(19) United States
(12) Patent Application Publication
(10) Pub. No.: US 2024/0013968 A1
(43) Pub. Date: Jan. 11, 2024

(54) COIL FOR A TRANSFORMER CORE

(71) Applicant: Hitachi Energy Switzerland AG, Baden (CH)

(72) Inventors: Antonio NOGUES, Zaragoza (ES); Rafael MURILLO, Zaragoza (ES); Carlos ROY, Zaragoza (ES); Lorena CEBRIAN, Zaragoza (ES); Victor Manuel GARCIA, Zaragoza (ES); Thomas GRADINGER, Aarau Rohr (CH)

(73) Assignee: Hitachi Energy Switzerland AG, Baden (CH)

(21) Appl. No.: 18/023,477

(22) PCT Filed: Dec. 22, 2021
(86) PCT No.: PCT/EP2021/087281

§ 371 Date: Feb. 27, 2023

(30) Foreign Application Priority Data
May 5, 2021 (EP) 21382405.5

(51) Int. Cl. H01F 27/28; H01F 27/24

(52) U.S. Cl. CPC H01F 27/2823; H01F 27/24

(57) ABSTRACT

A coil for a transformer core comprises a longitudinal axis, at least one multi-stranded conductor, at least one first conductor turn wound around the longitudinal axis, at least one second conductor turn wound around the longitudinal axis, the at least one first conductor turn being adjacent the at least one second conductor turn. Each of the at least one first and second conductor turns is provided with an electrically insulating member which extends about part but not an entire cross-sectional perimeter of the respective conductor turn, such that the at least one first and second conductor turns are insulated against each other. The electrically insulating member does not extend the entire cross-sectional perimeter of the respective conductor turn.

### CROSS REFERENCE TO RELATED APPLICATIONS

This application is a 35 U.S.C. § 371 national stage application of PCT International Application No. PCT/EP2021/087281 filed on Dec. 22, 2021, which in turn claims foreign priority to European Patent Application No. 21382405.5, filed on May 5, 2021, the disclosures and content of which are incorporated by reference herein in their entirety.

### BACKGROUND

The present disclosure relates to a coil for a transformer core.

A transformer is a passive electrical device that transfers electrical energy from one electrical circuit to another, or to multiple circuits. A typical transformer comprises a ferromagnetic core having several, e.g., three parallel columns or limbs, which are often oriented vertically, extending between a first yoke and a second yoke. Coils or windings are wound around the limbs. A varying current in any one of the coils produces a varying magnetic flux in the core, which induces a varying electromotive force across any other coil wound around the core.

A coil 100, as also generally illustrated in FIG. 6, typically comprises at least one electrical conductor 110 wound in a plurality of turns 120 around a longitudinal axis L of the coil 100. The conductor 110 is embedded, for example, in cast resin (not shown in FIG. 6).

A medium-frequency transformer (MFT) is a typical component in a power-electronic system. Due to the operating frequencies above 1 kHz, for example in the range of 10 kHz, the conductor 110 of the coil 100 of an MFT is typically made from litz wire. A litz wire is a type of conductor which is configured to reduce losses due to skin effects and proximity effects which may occur during transmission of an alternating current through the conductor 110. A litz wire typically consists of many thin strands, which are twisted or woven together. Thus, a litz wire is a multi-stranded conductor.

Although the strands of a litz wire are individually insulated, a further insulation is regularly required between adjacent turns 120 of the conductor 110 in order to avoid dielectric failures, especially between first turns, i.e., turns near the longitudinal ends of the coil 100, as indicated by example for the upper longitudinal end in FIG. 6 by an arrow and exclamation mark.

A prototype of a dry MFT comprises litz wires completely wrapped with a Nomex tape to provide a reliable turn-to-turn insulation. Nomex is a synthetic, aromatic polyamide polymer and shows very good chemical, mechanical and electrical resistance. However, it has been found that this configuration is not optimally suited in case of a dry transformer, since the Nomex tape may preclude resin from completely embedding the litz wire during manufacturing of the coil. This may result in air remaining between the litz wire and the Nomex tape. Such air between the litz wire and the Nomex tape may negatively affect insulation and may contribute to increased levels of partial discharges during operation of the transformer.

Alternatively, unwrapped litz wires can be used together with mechanical separators 130, as visualized in FIG. 6b, positioned between adjacent turns 120. The gaps between the adjacent turns formed in this way are subsequently filled with resin to ensure proper electrical insulation. However, this design requires a more complex fabrication.

Therefore, there is a need for an improved coil for a transformer core and an improved transformer core.

### SUMMARY

This object is achieved by the independent claims. Dependent claims refer to preferred embodiments. Additional or alternative aspects of the present disclosure are addressed throughout this specification.

According to the present disclosure a coil for a transformer core is provided comprising a longitudinal axis. Said longitudinal axis may coincide with the longitudinal axis of the limb of a transformer. There is provided at least one multi-stranded conductor. At least one first conductor turn is wound around the longitudinal axis, and at least one second conductor turn is wound around the longitudinal axis, the at least one first conductor turn being adjacent the at least one second conductor turn. The first and second conductor turn may be part the same or different multi-stranded conductor. The first and second conductor turn may be axially, i.e., in the direction of the longitudinal axis, or radially, i.e., in a direction perpendicularly to the longitudinal axis, adjacent one another.

Each of the at least one first and second conductor turns is provided with an electrically insulating member which extends about part but not an entire cross-sectional perimeter of the respective conductor turn, such that the adjacent at least one first and second conductor turns are insulated against each other.

Since the electrically insulating member does not extend about the entire cross-sectional perimeter of the respective conductor turn, a portion of the surface of the conductor turn is not covered by the electrically insulating member. In this way, e.g., cast resin, for example epoxy resin may directly contact a portion of the surface of the conductor turn. Also, the contact region between the electrically insulating member and the conductor turn is closed about A cross-sectional periphery of the conductor turn but opens into the area where there is no electrically insulating member. This has been found to eliminate or at least significantly reduce the risk of air remaining between the conductor turn and the electrically insulating member. As a result, undesired partial discharges during an operation of the transformer can be reduced.

The coil is particularly suited for a transformer core designed for a dry transformer as well as for an oil immersed transformer.

As specified, the electrically insulating member extends about part but not an entire cross-sectional perimeter of the respective conductor turn. This condition may hold true for at least part of the length of the at least one first and/or second conductor turn or for at least one entire turn or for a plurality of turns. The at least one multi-stranded conductor may comprise a plurality of turns.

The electrically insulating member may continuously extend along the whole length of a turn or a plurality of turns of the respective conductor.

The multi-stranded conductor may comprise or may be formed by strands which are provided with individual isolating elements. The multi-stranded conductor may comprise or may be a litz wire. The multi-stranded conductor may comprise or may be a continuously transposed conductor (CTC).

The electrically insulating member may be configured to avoid dielectric failure during an operation of the transformer. The electrically insulating member may be provided in addition to the isolation of the individual strands.

The at least one first conductor turn may be formed by the at least one multi-stranded conductor. The at least one second conductor turn may be formed by the at least one multi-stranded conductor. The at least one first conductor turn and the at least one second conductor turn may be formed by one multi-stranded conductor of the at least one multi-stranded conductor. In some embodiments, the at least one multi-stranded conductor may comprise a first multi-stranded conductor and a second multi-stranded conductor, wherein the at least one first conductor turn is formed by the first multi-stranded conductor and the at least one second conductor turn is formed by the second multi-stranded conductor.

The multi-stranded conductor may comprise two or more components, wherein each component may be formed by a multi-stranded conductor element or wire element.

The at least one first conductor turn being adjacent the at least one second conductor turn means that there is no further conductor turn between the at least one first conductor turn and the adjacent at least one second conductor turn.

The electrical insulation between the at least one first conductor turn and the at least one second conductor turn may be realized by at least one of the electrically insulating members of the at least one first and second conductor turns.

The cross-sectional perimeter of the respective conductor turn may be a perimeter in a cross-section taken in a plane in which the longitudinal axis extends, i.e., in a plane spanned by the longitudinal axis and an axis which is oriented perpendicular to the longitudinal axis. This cross-section is hereinafter also denominated as “longitudinal cross-section”. Herein, “axially” means along a direction parallel to the longitudinal axis and “radially” means along a direction perpendicular to the longitudinal axis. Additionally or alternatively, the cross-section may be defined as laying in a plane whose normal vector is given by the longitudinal axis of the conductor at the position of the cross-section.

The at least one first conductor turn being adjacent the at least one second conductor turn may mean that in the longitudinal cross-section, a one side of a cross-section of the at least one first conductor turn and one side of a corresponding, i.e., taken in the same plane, cross-section of the adjacent at least one second conductor turn face each other. These sides may be radially or axially extending sides.

Each of the at least one first and second conductor turns may exhibit a substantially rectangular or rectangular cross-section.

The rectangular cross-section allows for a space saving configuration of the coil. As seen in the longitudinal cross-section, the side surfaces of the rectangular cross-section may have for example an extension of between 5 mm and 40 mm.

Each of the at least one first and second conductor turns may exhibit four circumferential side surfaces, which may also be referred to as perimetral side surfaces, two axially extending surface and two radially extending surfaces. An edge region may be formed at a transition between a first and an adjacent second side surface, respectively.

The electrically insulating member of the at least one first conductor turn may be arranged such that it is provided to or contact a portion of a surface of the conductor turn. The electrically insulating member may be provided to or contact the conductor turn on at least one of its four circumferential side surfaces, for example on one side surface or on two side surfaces. Moreover, the electrically insulating member may extend over or cover at least one edge region of the conductor turn. When seen in cross section, the insulating member may fully extend along one of the two side surfaces forming the edge region and extend along only part of the other one of the two side surfaces forming the edge region.

For example, in its cross-section, the electrically insulating member may fully extend along one of the side surfaces of the conductor turn but only along between 20% and 80% of another one or two of the side surfaces, in some embodiments along less than 70%, for example along between 30% and 70%. A fourth and eventually also a third of the four side surfaces may not be covered by electrically insulating member.

In particular, the majority of at least two side surfaces may not be insulated or covered by the respective electrically insulating member. In this way resin, for example epoxy resin may particularly suitably contact the surface of the conductor turns during manufacturing of the coil while avoiding air to remain between the electrically insulating member and the conductor.

The electrically insulating member may only extends around less than 70% of the cross-sectional perimeter of the respective conductor turn, for example less than 50% or less than 40%. Besides the above-mentioned effect, this may also contribute to reduction of costs.

In some embodiments at least 5% of the conductor turn's cross-sectional perimeter is not covered by the electrically insulating member, for example at least 10%, at least 20%, or at least 30%.

For two axially and/or radially adjacent conductor turns each turn has one side surface facing a side surface of the respective adjacent turn. The arrangement of two axially and/or radially adjacent conductor turns may be such that only one of the two side surfaces facing one another (first side surface) is provided with an electrically insulating member fully extending along said side surface while the other one of the two side surfaces facing one another (second side surface) does not have an electrically insulating member or is provided with an electrically insulating member extending along only part of said side surface, for example as discussed above.

The electrically insulating member may be a tape.

It may be advantageous, if the amount of electrically insulating member is reduced since in this way, costs can be saved. Still, a sufficient amount and particularly a sufficient amount in appropriate locations may have to be applied in order to ensure proper insulation.

A part of the perimeter of the respective conductor turn is particularly not covered with the electrically insulating member. In this manner resin may come in contact particularly suited with the conductor turn.

The electrically insulating member may comprise or consist of aramid fibers. For example, the electrically insulating member may comprise or consist of Nomex.

The coil may further comprise a holding element for holding the electrically insulating member to the respective conductor turn. This may be advantageous with respect to a simple manufacturing. The holding element may be wrapped around the respective conductor turn and its electrically insulating member.

The holding element may be permeable to resin, for example, permeable to epoxy resin. For example, the holding element may comprise or may be made of fiberglass.

A portion of the respective conductor turn may be not covered by the holding element. In this way, the resin can come into contact with the surface of the conductor turn during manufacturing of the coil easily. In some embodiments, the holding element may be wrapped around the respective conductor turn completely, i.e., such that the entire surface of the respective conductor turn is covered by the holding element. For example, the conductor turn may be completely wrapped by the holding element. Permeability of the holding element to resin may then allow resin to come into contact with the conductor turn.

The holding element may be helically wound around the conductor in a plurality of turns.

The coil may further comprise a resin member embedding the respective conductor turns and directly contacting at least a portion of the respective conductor turns. The resin member may be cast resin. The resin member may be an epoxy resin member. In this way the respective conductor turns may be suitably impregnated with resin.

The at least one first conductor turn and the at least one second conductor turn may be axially and/or radially adjacent. For example, the coil may comprise a first layer of conductor turns and a second layer of conductor turns, wherein the first layer is positioned radially closer to the longitudinal axis as compared to the second layer. For example, the first layer may be formed by the at least one first conductor turn, and the second layer may be formed by the at least one second conductor turn. Alternatively or additionally, first and second conductor may provide axially alternating turns. As will be readily understood by those of skill in the art, the present disclosure is applicable to coils formed of one, two, three or more multi-stranded conductors.

### BRIEF DESCRIPTION OF DRAWINGS

The subject-matter of the disclosure will be explained in more detail with reference to preferred exemplary embodiments which are illustrated in the attached drawings, in which:

FIG. 1 a is a schematic side view of a transformer core.

FIG. 2 is a schematic perspective view of a partially sectioned coil for a transformer.

FIG. 3 is a schematic perspective view of a coil according to the disclosure.

FIG. 4 is schematic sketch of a further example of a coil.

FIG. 5 shows a portion of a litz wire member of the coil prior to be wound around the longitudinal axis L.

FIG. 6 is a sketch of a coil according to prior art illustrating mechanical separators arranged between adjacent turns of the coil.

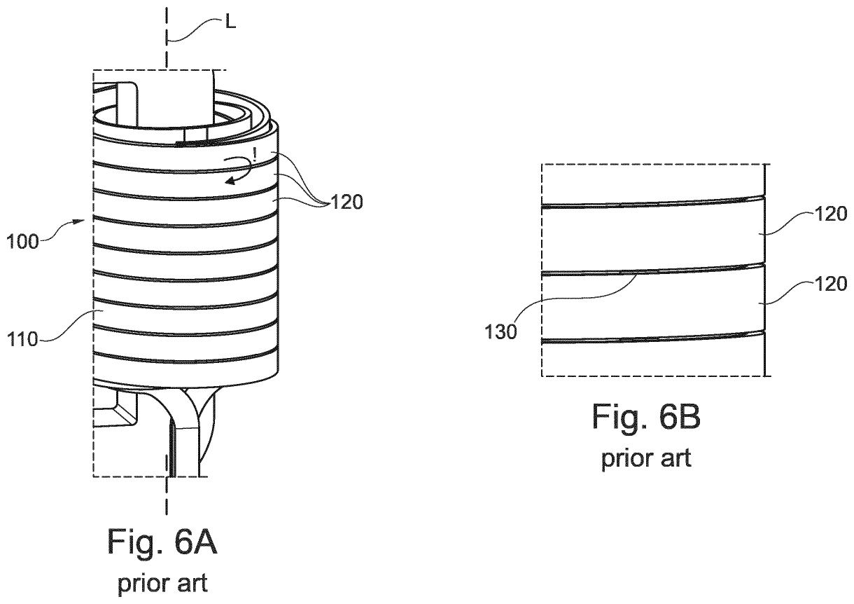

### DETAILED DESCRIPTION

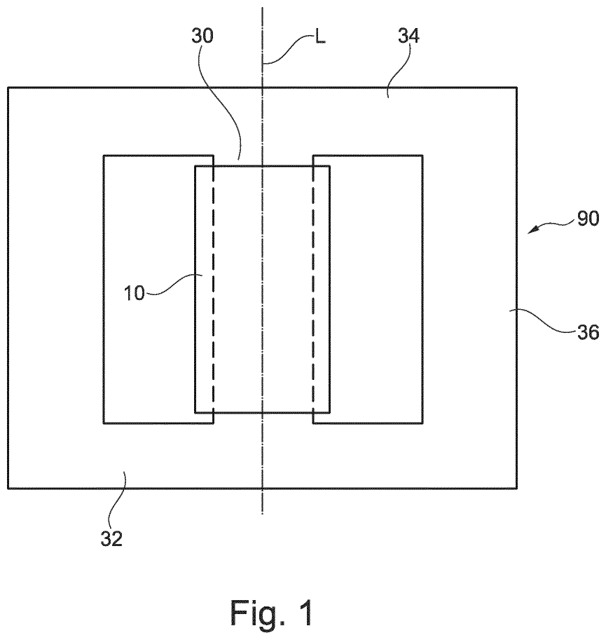

FIG. 1 a is a schematic side view of a transformer core 90. The transformer core 90 comprises a column 30 extending between a first yoke 32 and a second yoke 34. The transformer core 90 may comprise at least one further column 36, extending between the first yoke 32 and the second yoke 34.

The column 30 extends along a longitudinal axis L. A coil 10 is wound around the column 30. The coil 10 comprises a longitudinal axis L that particularly coincides with the longitudinal axis L of the column 30.

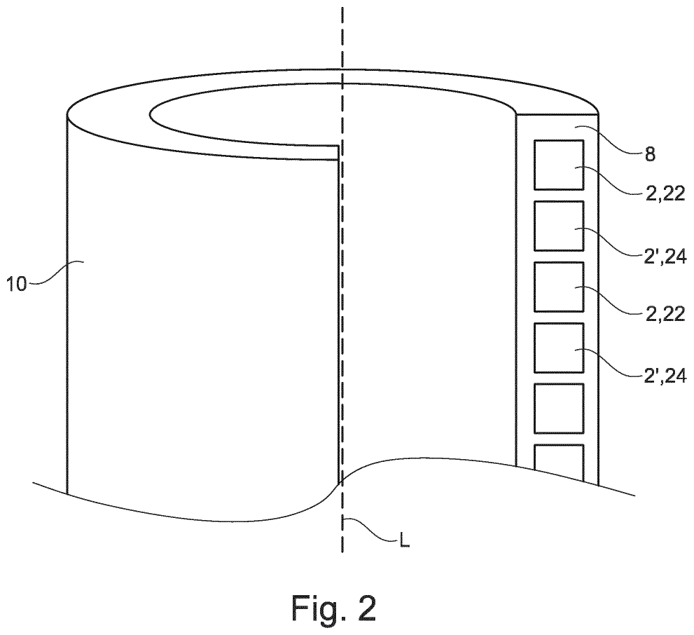

FIG. 2 is a schematic perspective view the coil 10, partially sectioned and separated from the core 90. The coil 10 comprises at least one multi stranded conductor 2. The multi-stranded conductor may be a litz wire member 2 or a CTC.

The multi stranded conductor 2 is wound around the longitudinal axis L, particularly in a helical way such that the multi stranded conductor 2 forms at least one first conductor turn 22. A “turn” as used herein is understood as being one circulation of the conductor, i.e. 360° about the longitudinal axis L. For example, the multi-stranded conductor 2 may form two or three or four and so on first turns and two, or three or four second turns, respectively. More generally, the multi-stranded conductor 2 may form a plurality of first conductor turns 22. A second conductor turn 24 may be formed by the multi stranded conductor 2 or alternatively—as shown in FIG. 2—by a further multi stranded conductor 2′. More generally, the further multi stranded conductor 2′ may form a plurality of second conductor turns 24.

It is to be understood, as discussed above, that one conductor turn comprises one or two or more turns of multi-stranded conductor elements, which are not necessarily insulated against one another. This is of particular advantage, in case the coil is formed, for example, of a multi-stranded conductor which comprises more than one multi-stranded conductor element, for example, two parallel litz wires. In this case the insulation must be particularly ensured between turns of the multi-stranded conductor rather than between the turns of the multi-stranded conductor elements, i.e., the parallel elements within one multi-stranded conductor.

The at least one conductor turn 22 may be adjacent the at least one second conductor turn 24. In the example illustrated in FIG. 2, the at least one first and the second conductor turns 22, 24 are adjacent each other along the longitudinal axis L, i.e., axially adjacent.

The conductor turns 22, 24 are surrounded by or embedded within a resin member 8. The resin member 8 of the coil 10 may be manufactured by casting resin around the conductor turns 22, 24 within a process step for manufacturing the coil 10.

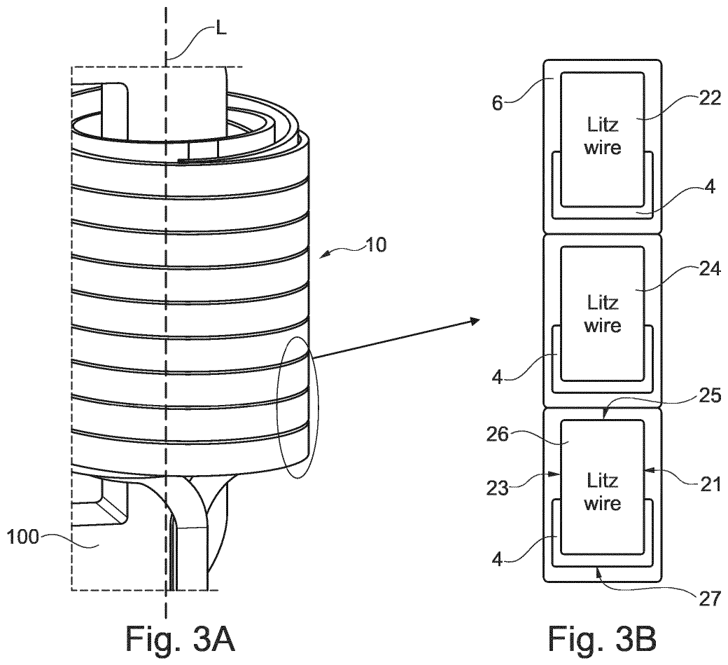

FIGS. 3A, 3B are further schematic perspective view of the coil 10, illustrating a case, where the at least one first conductor turn 22 is formed by a first multi stranded conductor 2 and the at least one second conductor turn 24 is formed by a second multi stranded conductor 2′.

In FIG. 3B, corresponding example cross-sections of the first and second conductor turns 22, 24 are sketched, as seen in a longitudinal cross-section of the coil 10, i.e., in a cross-section of the coil 10 including the longitudinal axis L (here, a cross-section in the paper plane of FIG. 3A). In addition, a corresponding example third conductor turn 26 is sketched axially adjacent the second conductor turn 24.

Each of the first conductor turn 22 and the second conductor turn 24 is provided with an electrically insulating member 4 which extends about part but not the entire cross-sectional perimeter of the respective conductor turn 22, 24 such that the first conductor turn 22 and the second conductor turn 24 are insulated against each other. The perimeter of the respective conductor turn 22, 24 is a perimeter in the longitudinal cross-section of the coil 10. In the illustrated example, the electrical insulation between the first conductor turn 22 and the second conductor turn 24 is realized by the electrically insulating member 4 of the first conductor turn 22 but not by the electrically insulating member 4 of the second conductor turn 24.

The conductor turns 22, 24, 26 may exhibit a substantially rectangular cross-section. In this way, the conductor turns exhibit four circumferential or perimetral side surfaces, respectively, namely a radially outward facing surface 21 (extending axially), a radially inward facing surface 23 (extending axially), a first axially facing surface 25 (extending radially), and a second axially facing surface 27 (extending radially), as indicated in FIG. 3 exemplarily for the third conductor turn 26.

It is to be noted that the discussion of first and second conductor turns may be understood to not only refer to those indicated by specific reference numerals, e.g., 22 and 24 in FIG. 3B but also to other adjacent turns, such as those indicated by reference numerals 24 and 26. Similarly, the discussion of one conductor turn may equally apply to another conductor turn.

In the illustrated example, the majority of at least two side surfaces, here a majority of the radially outward facing surface 21, the radially inward facing surface 23 and the first longitudinally facing surface 25 is not insulated or not covered, at least not fully covered, by the corresponding electrically insulating member 4.

The electrically insulating member 4 may be arranged in such a way that it fully covers or fully extends along least one side surface of the respective conductor turn 26 (24, 22), here the second axially facing surface 27, wherein the electrically insulating member 4 only partly covers or only partly extends along the two respective adjacent side surfaces, i.e., here the radially outward facing surface 21 and the radially inward facing surface 23. The electrically insulating member 4 does not cover or does not extend along the fourth side surface, here axially facing surface 25.

The arrangement of two axially adjacent conductor turns 22,24 or 24, 26 is such that only one of the surfaces of these adjacent turns facing one another, e.g., the axially facing side 25 of first conductor turn 26 and the axially facing side 27 of second conductor turn 24, is insulated by the respective electrically insulating member 4 which fully extends along said side surface. The respective adjacent conductor turn's side surface 25 facing said insulated side surface is not or not fully isolated, i.e., the electrically insulating member 4 does not or only partly extend along said side surface 25.

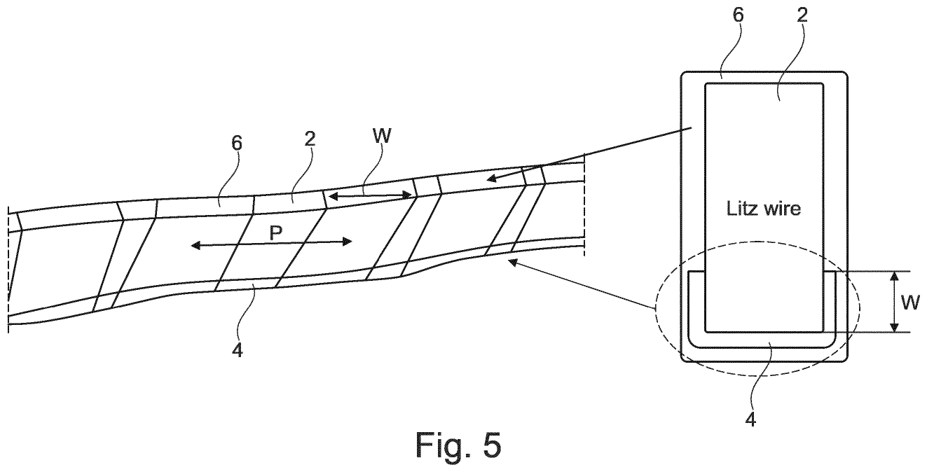

FIG. 5 illustrates a multi stranded conductor in a state before being wound to form a conductor turn. The electrically insulating member 4 is an elongate, flat element arranged along the main extension of the multi stranded conductor to cover the respective side surface or side surfaces of the multi stranded conductor. Thus, the electrically insulating element 4 of a conductor turn 22, 24, 26 of the coil 10 preferably may be an elongate member extending along part, the majority or the entire length of the respective conductor turn 22, 24, 26.

As can be further seen from FIGS. 3 and 5, the electrically insulating member 4 may be bent about the multi stranded conductor's periphery to not only extend along or fully cover one side surface thereof but to also extend about one of or the two edges delimiting said (completely covered) side surface and partly along a second and/or third side surface of the multi stranded conductor.

For example, the conductor turn 22, 24, 26 may have a cross-section with peripheral sides having extensions between 0.5 cm and 4 cm. The electrically insulating element 4 may fully extend along one of these peripheral sides 27 and only partly extend along a second and/or third peripheral side surface 21, 23, e.g., along a length w of between 1 mm and 5 mm for a side surface having a length of 20 mm. The electrically insulating member 4 does not extend along at least a fourth cross-sectional peripheral side surface 25 of the conductor turn. The length that the electrically insulating member 4 only partly extends along a side surface may be as short as possible while ensuring proper insulation of the fully covered side surface. As regards embodiments of ratios and lengths may also be referred to the above discussions.

The electrically insulating member 4 may be a tape made from aramid fibers, for example a Nomex tape.

The coil 10 further comprises a holding element 6 for holding the electrically insulating member 4 to the respective conductive turn 22, 24, 26. In some embodiments, the holding member 6 is permeable to resin. For example, the holding member 6 may be made from fiberglass.

The holding member 6 may be helically wound around the multi stranded conductor in a plurality of turns as illustrated by example in FIG. 5. In some embodiments, the holding member 6 is wound around the multi stranded conductor in such a way that a width W of the holding member 6 is smaller than a pitch P of the corresponding turns. Thus, a portion of the surface of the multi stranded conductor may remain not covered by the holding member 6. This is advantageous with respect to a direct contact between the multi stranded conductor and cast resin.

However, if the holding element 6 is permeable to resin, the multi stranded conductor may be alternatively wrapped by the holding element 6 in such a way that the complete surface of the multi stranded conductor is covered by the holding element 6.

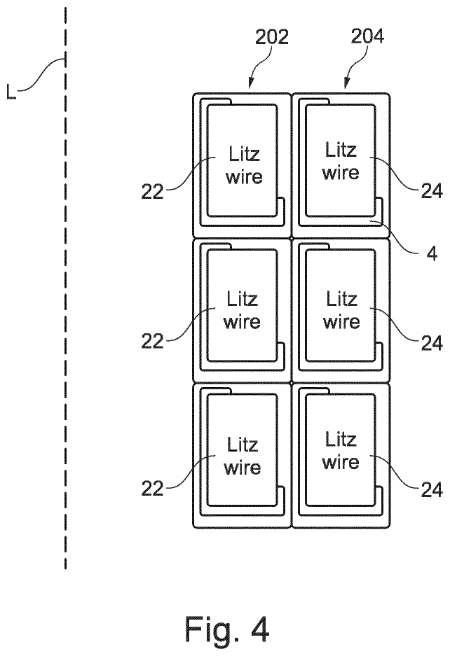

As schematically indicated in FIG. 4, the coil 10 may comprise a first layer 202 of conductor turns and a second layer 204 of conductor turns, wherein the first layer 202 is positioned radially inward or closer to the longitudinal axis L as compared to the second layer 204, which is positioned radially outwards or farther from the longitudinal axis L as compared to the first layer 202. For example, the first layer 202 may be formed by the at least one first conductor turn 22, and the second layer 204 may be formed by the at least one second conductor turn 24.

In this case, different conductor turns may be radially and axially adjacent of one another. Therefore, the electrically insulating element 4 in some embodiments is arranged in such a way that it fully extends along or covers at least two side surfaces of the respective conductor turns 22, 24, as can be seen in the cross-sectional view of FIG. 4. The electrically insulating element 4 only partly extends along the two remaining side surfaces of the conductor turns, as described above. In this case, there is no side surface along which the electrically insulating element 4 does not extend. However, two side surfaces remain uninsulated since the electrically insulating element 4 does not fully extend along or cover the surfaces. As discussed above, the electrically insulating element 4 may be provided such that only one of two adjacent facing side surfaces of adjacent turns is fully insulated while the other one is not fully insulated.

While the present disclosure has been described in detail in the drawings and forgoing description, such description is to be considered illustrative or examples and not restrictive. Variations to the disclosed embodiments can be understood and effected by those skilled in the art and practicing the claimed subject-matter, from a study of the drawings, the disclosure, and the appended claims. In the claims, the word “comprising” does not exclude other elements, and the indefinite article “a” or “an” does not exclude a plurality. The mere fact that certain elements or steps are recited in distinct claims does not indicate that a combination of these elements or steps cannot be used to advantage, specifically, in addition to the actual claim dependency, any further meaningful claim combination shall be considered disclosed.

1. A coil for a transformer core, comprising:
a longitudinal axis,
at least one multi-stranded conductor,
at least one first conductor turn wound around the longitudinal axis,
at least one second conductor turn wound around the longitudinal axis,
the at least one first conductor turn being adjacent the at least one second conductor turn,
wherein each of the at least one first and second conductor turns is provided with an electrically insulating member which extends about part but not an entire cross-sectional perimeter of the respective conductor turn, such that the at least one first and second conductor turns are insulated against each other.

2. The coil of claim 1, wherein of two axially and/or radially adjacent conductor turns each turn has one side surface facing a side surface of the respective adjacent turn, while only one of these surfaces facing one another is provided with the electrically insulating member fully extending along said side surface while the other one of the two side surfaces facing one another is not provided with an electrically insulating member or is provided with an electrically insulating member extending along only part of said side surface.

3. The coil of claim 1, wherein each of the at least one first and second conductor turns has a substantially rectangular cross-section with four circumferential side surfaces.

4. The coil of claim 3, wherein the majority of at least two side surfaces is not provided with an electrically insulating member.

5. The coil of claim 1, wherein the electrically insulating member only extends around less than 80% of the perimeter of the respective conductor turn, preferably less than 60%, more preferably less than 50%.

6. The coil of claim 1, wherein one side surface of the of the respective conductor turn is not provided with the electrically insulating member.

7. The coil of claim 1, wherein the multi-stranded conductor is a litz wire or a continuously transpose conductor.

8. The coil of claim 1, wherein the electrically insulating member comprises or consists of aramid fibers.

9. The coil of claim 1, further comprising a holding element for holding the electrically insulating member to the respective conductor turn.

10. The coil of claim 9, wherein the holding element is permeable to resin.

11. The coil of claim 9, wherein a portion of the respective conductor turn is not covered by the holding element.

12. The coil of claim 1, further comprising a resin member embedding the respective conductor turns.

13. The coil of claim 1, wherein the at least one first conductor turn and the at least one second conductor turn are axially and/or radially adjacent to one another.

14. A transformer comprising the coil of claim 1, the transformer comprises a ferromagnetic core, wherein the coils are wound around the core.

15. The transformer of claim 14, wherein the transformer is an oil-immersed transformer or a dry transformer.

16. A coil for a transformer core, comprising:
a longitudinal axis,
at least one multi-stranded conductor,
at least one first conductor turn wound around the longitudinal axis,
at least one second conductor turn wound around the longitudinal axis,
the at least one first conductor turn being adjacent the at least one second conductor turn, and a resin member embedding the respective conductor turns,
wherein each of the at least one first and second conductor turns is provided with an electrically insulating member which extends about part but not an entire cross-sectional perimeter of the respective conductor turn, such that the at least one first and second conductor turns are insulated against each other, and
wherein the at least one first conductor turn and the at least one second conductor turn are axially and/or radially adjacent to one another.

17. The coil of claim 16, further comprising a holding element that is permeable to resin for holding the electrically insulating member to the respective conductor turn.

18. The coil of claim 16, wherein of two axially and/or radially adjacent conductor turns each turn has one side surface facing a side surface of the respective adjacent turn, while only one of these surfaces facing one another is provided with the electrically insulating member fully extending along said side surface while the other one of the two side surfaces facing one another is not provided with an electrically insulating member or is provided with an electrically insulating member extending along only part of said side surface.

19. The coil of claim 1, wherein each of the at least one first and second conductor turns has a substantially rectangular cross-section with four circumferential side surfaces, and wherein the majority of at least two side surfaces is not provided with an electrically insulating member.

20. A transformer comprising the coil of claim 16, the transformer comprising a ferromagnetic core, wherein the coils are wound around the core.
